(19) United States
(12) Patent Application Publication
(10) Pub. No.: US 2003/0052927 A1
(43) Pub. Date: Mar. 20, 2003

(54) System and method for indicating a status of multiple features of a data processing system

(75) Inventors: Molly Kestner Barksdale, Austin, TX (US); Denise Ann Bell, Austin, TX (US); Bethany Lyn Kessen, Apex, NC (US); Martin Thomas Moore, San Francisco, CA (US); Darren Kelly Upton, Raleigh, NC (US)

Correspondence Address: BRACEWELL & PATTERSON, L.L.P., P.O. BOX 969, AUSTIN, TX, 78767-0969, US

(73) Assignee: International Business Machines Corporation, Armonk, NY

(21) Appl. No.: 09/957,017

(22) Filed: Sep. 20, 2001

(51) Int. Cl. G09G 5/00

(52) U.S. Cl. 345/854

(57) ABSTRACT

A data processing system, which includes a processor and a memory, is equipped with a system resource monitor, executable by the processor and stored in the memory, that displays a multi-level tree structure in which each level includes a textual identification for a respective one of multiple features in the data processing system. The features are monitored by the system resource monitor for information regarding the status of the features. This information further indicates a normal status or a notification status. If the information indicates a notification status, the system resource monitor also displays a notification indicia. If the monitored status includes more than one attribute, the placeholder icon and notification indicia are displayed in a window adjacent to the tree structure.

### CROSS-REFERENCE TO RELATED APPLICATION

This patent application is related to U.S. patent application Ser. No. 09/906,351 entitled “System and Method for Indicating a Status of Multiple Features of a Data Processing System,” which was filed on Jul. 16, 2001, is assigned to the assignee of the present application, and is incorporated herein by reference.

### BACKGROUND OF THE INVENTION

1. Technical Field

The present invention relates in general to data processing systems, and more particularly, monitoring of data processing systems. Still more particularly, the present invention relates to a system and method for displaying the status of data processing system features.

2. Description of the Related Art

The tree structure view is an increasingly popular view of hierarchical relationships of data and/or features of a data processing system. For example, the Microsoft Windows™ 95/98/NT/2000/ME operating systems implement a system management interface and directory listings in a tree structure view.

In a system management interface 100, as depicted in FIG. 3A, hierarchical relationship s are typically illustrated by depicting an icon 102 and a textual identification 104 that represents a root feature. A feature is herein defined as “a unique, attractive, or desirable property of a program or of a computer or other hardware.” Related and/or department features are depicted in a similar fashion, but are indented below the root feature. Icons 102 are generally redundant with the textual identification 104 and do not add additional information. Typically, icon 102 is colorful and detailed, which generally distracts the user from relevant information displayed in the tree structure.

Users (e.g., network administrators) frequently monitor the data processing system features for a change of states. System management interface 100 illustrated in FIG. 3A displays a graphical notification of a notification state to the user by simply adding a small overlay icon to icon 102. The small overlay icons must compete with the already cluttered system management interface to alert the user of a change of the state of a feature of the data processing system. The first overlay icon is a warning icon 106 that indicates that the specified feature has encountered a condition where a program error and/or hardware failure may occur, herein referred to as a “warning status.” The second overlay icon is an error icon 108 that indicates that the specified feature has encountered a program error and/or hardware failure, herein referred to as an “error status.”

The cluttered system management interface requires tedious visual discrimination between highly similar icons to detect a change in operating conditions. Consequently, it would be desirable to provide an improved system and method for indicating the status of multiple features in a data processing system.

### SUMMARY OF THE INVENTION

To overcome the foregoing and additional limitations in the prior art, the present invention provides an improved data processing system and method for indicating the status of multiple features within the data processing system. The data processing system includes a processor, a memory, and a system resource monitor stored in the memory and executable by the processor.

The system resource monitor displays a multi-level tree structure where each level includes a textual identification of a respective one of multiple features in the data processing system. The features are monitored by the system resource monitor for information regarding the status of the features. If the information indicates a notification status (e.g., any status that requires a user to be notified), the system resource monitor displays one of various graphically distinct notification indicia in place of the placeholder icon. If the monitored status includes more than one attribute, the placeholder icon and notification indicia are displayed in a window adjacent to the tree structure.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of an exemplary data processing system, which may be utilized to implement the present invention;

FIG. 2 illustrates a layer diagram of the software utilized to implement a preferred embodiment of the present invention;

FIG. 3A depicts a graphical user interface (GUI) of a system manager according to the prior art;

FIG. 3B illustrates a GUI of a system resource monitor in accordance with a first preferred embodiment of the present invention;

FIG. 4A depicts a GUI of a system resource monitor in accordance with a preferred embodiment of the present invention;

FIG. 4B illustrates a GUI of a system resource monitor in which a window displaying multiple attributes can be resized utilizing a resizing tool in accordance with a preferred embodiment of the present invention;

FIG. 4C depicts a GUI of a system resource monitor in which the display order of a set of columns may be altered in accordance with a preferred embodiment of the present invention;

FIG. 4D illustrates a GUI of a system resource monitor in which a selection of viewable attributes may be made utilizing a pull-down menu in accordance with a preferred embodiment of the present invention;

FIG. 4E depicts a GUI of a system resource monitor in which a hovering title bar description is displayed in accordance with a preferred embodiment of the present invention;

FIG. 4F illustrates a GUI of a system resource monitor in which the title bar descriptions are textual descriptions in accordance with a preferred embodiment of the present invention; and

FIG. 5 depicts a high-level logic flowchart of a method of indicating a status of a respective one of a plurality of features within a data processing system to a user in accordance with a preferred embodiment of the present invention.

### DETAILED DESCRIPTION OF THE PREFERRED EMBODIMENT

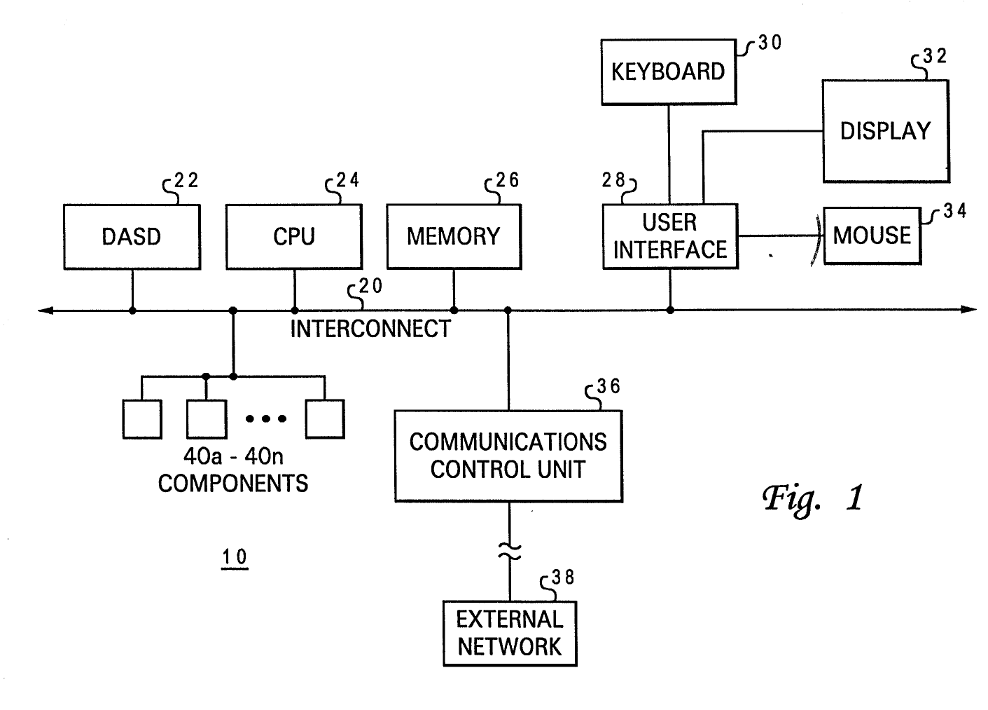

With reference now to the figures and in particular with reference to FIG. 1, there is depicted a detailed block diagram of a data processing system 10 in which a preferred embodiment of the present invention maybe implemented. As illustrated, data processing system 10 includes a DASD 22, CPU 24, memory 26, user interface 28, communication control unit 36, and multiple components 40a-40n coupled by a system interconnect 20. It should be readily apparent to those skilled in the art that system interconnect 20 may be implemented as one or more buses, switches or any other type of coupling apparatus. Central processing unit (CPU) 24, which maybe implemented as one or more processors, such as any generation of Pentium™ processor available from Intel Corporation in Santa Clara, Calif., executes software instructions to control the operation of data processing system 10.

Memory 26 provides storage for software and data and may include both read-only memory (ROM) and random access memory (RAM). Direct access storage device (DASD) 22 provides additional non-volatile storage for data processing system 10. DASD 22 may include, for example, a CD-ROM, a CD-RW, a DVD disk drive, a hard disk drive, and/or a floppy disk drive.

User interface 28 provides an interface between data processing system 10 and peripherals employed by a user to interact with data processing system 10. User interface 28 may include various adapters and drivers for controlling peripherals, such as keyboard 30, display 32, and mouse 34. Communications control unit 36 provides an interface between data processing system 10 and an external network 38, which may be a local area network (LAN) or a wide area network (WAN) such as the Internet. Components 40a-40n can be any type of peripheral, such as additional controller cards or adapters.

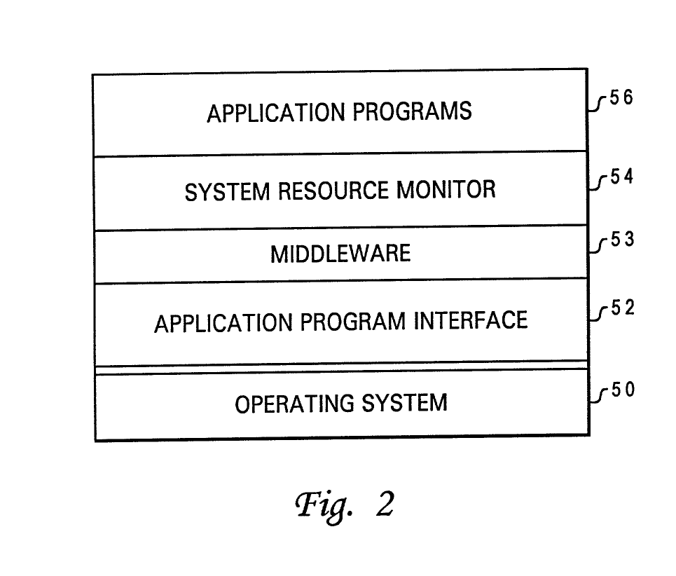

Referring to now FIG. 2, an exemplary layer diagram of the software configuration of data processing system 10 is illustrated. As well known in the art, a data processing system requires a set of program instructions, known as an operating system, to function properly. Basic functions (e.g., saving data to a memory device or controlling the input and output of data by the user) are handled by operating system 50, which may be at least partially stored in memory 26 and/or DASD 22 of data processing system 10. A set of application programs 56 for user functions (e.g., e-mail programs, word processors, Internet browsers), runs on top of operating system 50. As shown, system resource monitor 54 and application programs 56 access the functionality of operating system 50 via an application program interface 52. Alternatively, system resource monitor 54 can be implemented as part of operating system 50, or as middleware 53.

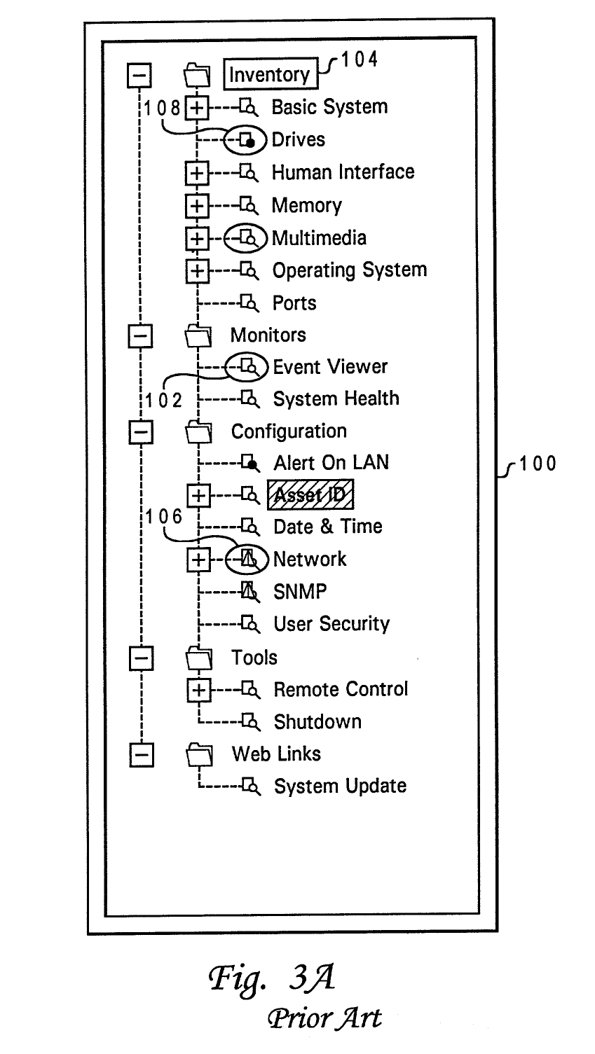

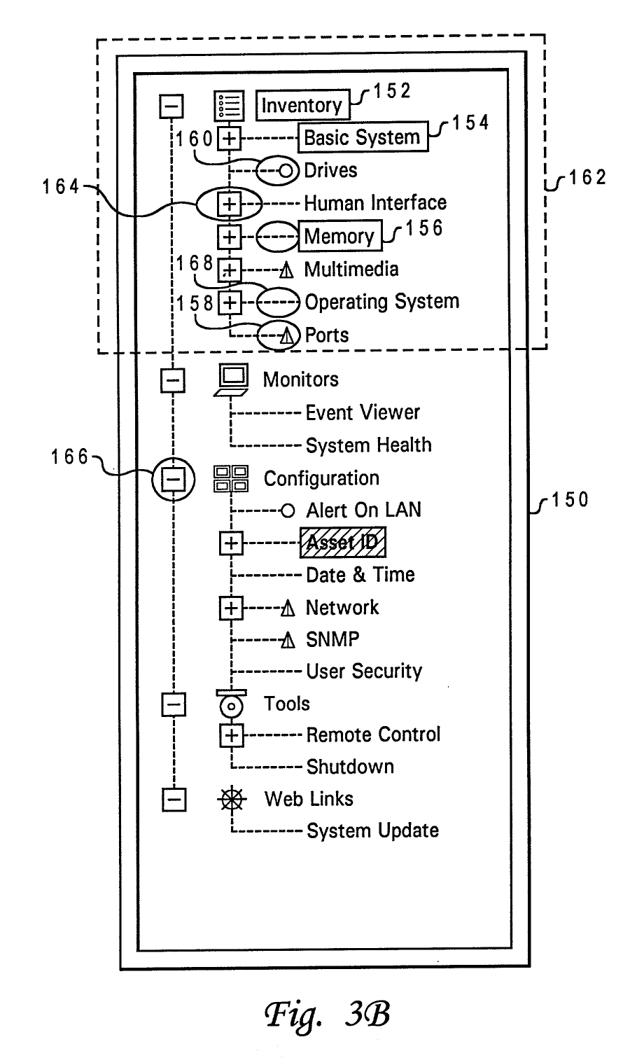

With reference to FIG. 3B, there is depicted a graphical user interface (GUI) of system resource monitor 54, herein referred to as system resource monitor interface 150. As shown, multiple features of data processing system 10 are organized in a multi-level tree structure 162. For example, CPU 24, user interface 28, and components 40a-40n are considered hardware features, while operating system 50 and application programs 56 are examples of software features. Multi-level tree structure 162 is a data structure including one or more nodes that are linked together in a hierarchical fashion. A root node, or the base of multi-level tree structure 162, can have related child nodes. By selecting a first expansion block 164 displaying a “+” sign next to a root node in system resource monitor interface 150 utilizing mouse 34, the user invokes display of all related child nodes. However, if a second expansion block 166 displaying a “−” sign next to a root node is selected by the user utilizing mouse 34, all child nodes related to the root node are hidden from the user to present a simplified view of multi-level tree structure 162.

Features of the data processing system are monitored by system resource monitor 54 for one of two states: a normal status or a problem status. Features such as “Inventory” 152, herein referred to as “root features,” occupy the top of a multi-level tree structure 162. Indented below and related to the independent features are “child features,” such as “basic system” 154. System resource monitor interface 150 displays a placeholder icon 168 and a textual identification 156 of a feature if system resource monitor 54 observes a normal status from the feature. However, if system resource monitor 54 observes a notification status from the feature, various graphically distinct indicia are displayed next to textual identification 156 of the feature by system resource monitor interface 150, depending on the type of notification status. Notification indicia 158 and 160 are graphical icons implemented as bitmaps.

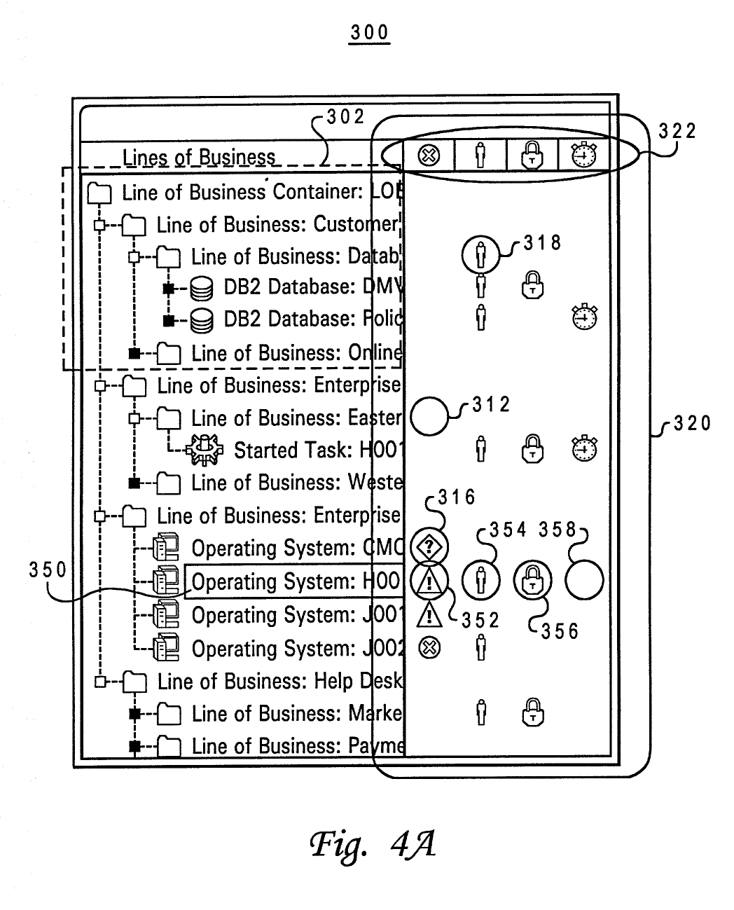

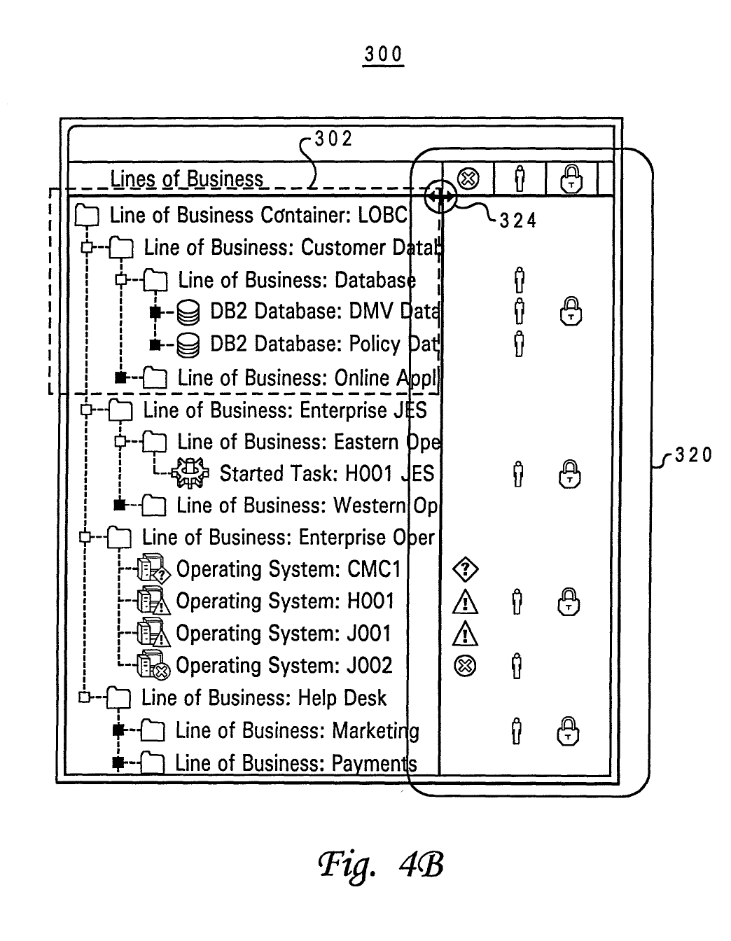

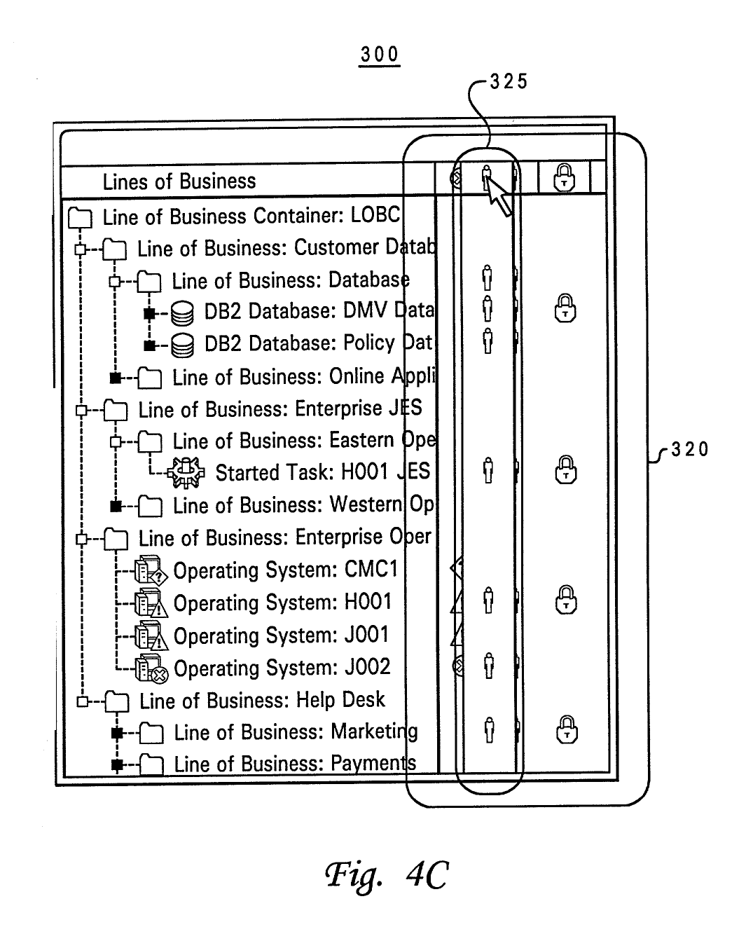

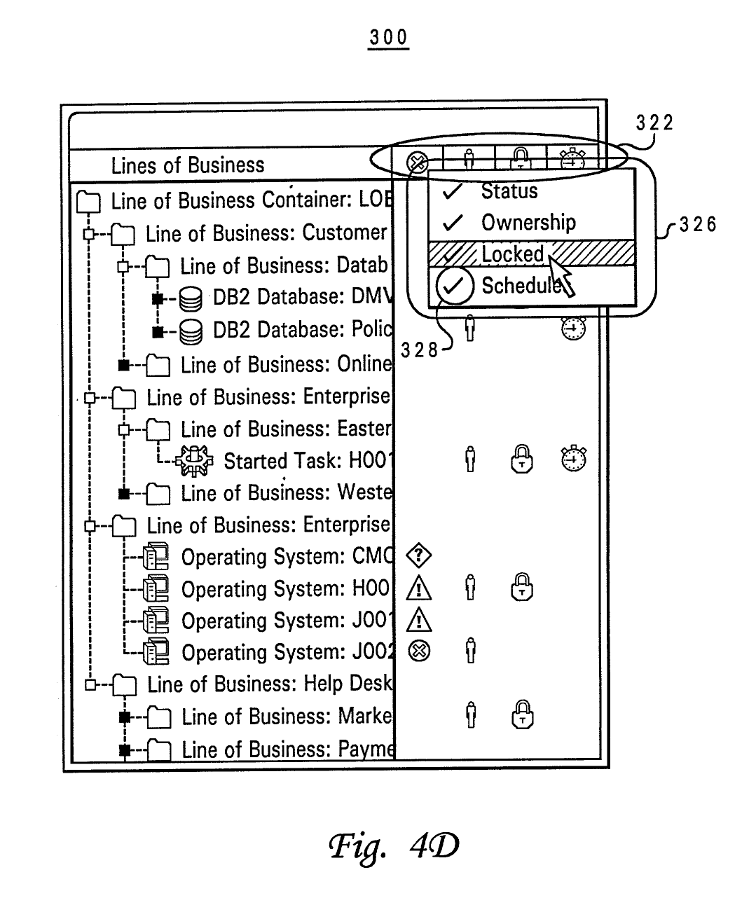

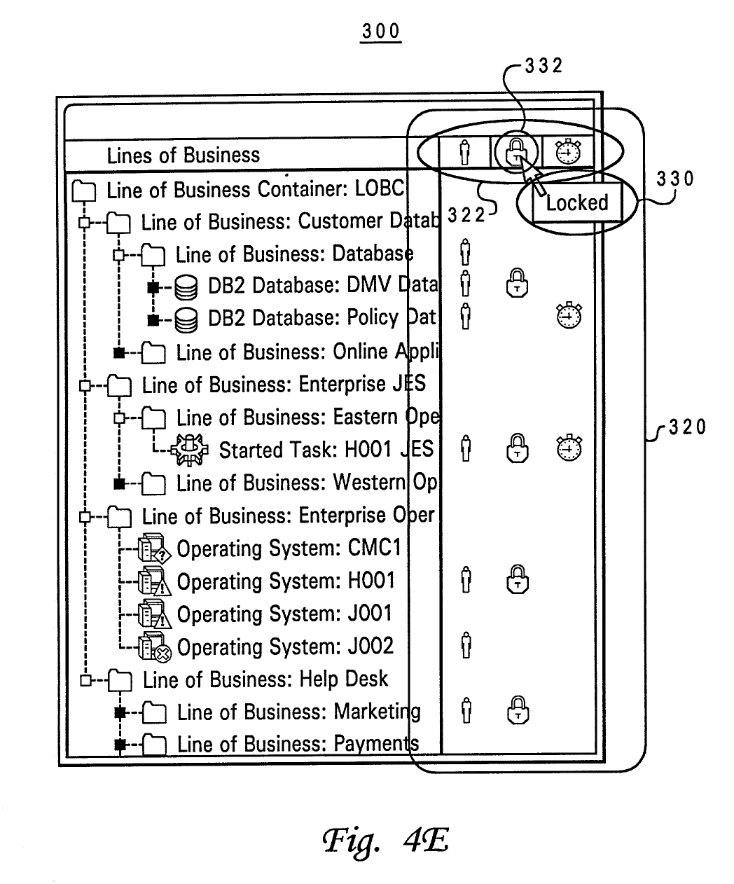

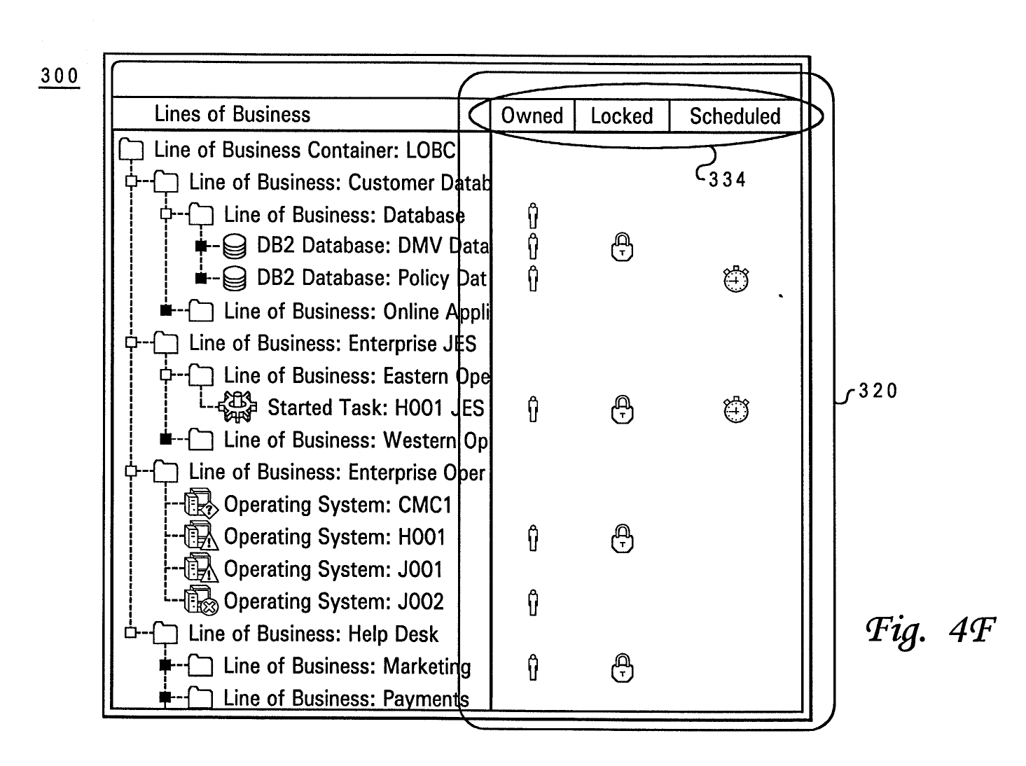

Referring to FIG. 4A, there is depicted a graphical user interface (GUI) for system resource monitor 54, herein referred to as system resource monitor interface 300, which facilitates the visual discrimination of notification indicia, in the case when the monitored status includes multiple attributes, according to a preferred embodiment of the present invention. As shown, multiple features of data processing system 10 are organized in a multi-level tree structure 302. Features such as “Line of Business: Container” 308 are considered root features and occupy the top level of tree structure 302. Indented below and related to the independent features are “child features,” such as “Line of Business: Customer” 310. Features of the data processing system are monitored by system resource monitor 54 in order to provide an indication of the status of the feature. However, this status may include more than one attribute. System resource monitor 54 determines whether or not each observed attribute is in a normal or notification state. Some of the attributes monitored by system resource monitor 54 are indicated in a title bar 322 of window 320 adjacent to multi-level tree structure 302. Window 320 further includes rows that indicate to the user the status (and the setting of each attribute) of each feature of the data processing system. The columns in window 320 designate the various attributes that comprise the status of a data processing system feature.

During feature status monitoring by system resource monitor 54, system resource monitor interface 300 displays a “blank” placeholder icon 312 or other indicator of normal state in a correct row and column of window 320 if an attribute has a normal state. However, if system resource monitor 54 observes a notification state from the feature's attribute, various graphically distinct indicia are displayed in window 320 in a field corresponding to the monitored feature, depending on the type of notification state. Notification indicia 316 and 318 are graphical icons implemented as bitmaps.

For example, referring again to FIG. 4A, system resource monitor interface 300 includes feature “Operating System: H001” 350. Window 320, adjacent to tree structure 302 includes a row directly adjacent to “Operating System H001” 350 that reports the status of the feature. The status comprises four attributes: an (1) operational state, a (2) message alert state, a (3) security state, and a (4) a scheduling state. A warning indica 352 displayed in the operational state attribute space indicates to the user that the “Operating System: H001” 350 may have encountered a condition in which a program error and/or hardware failure may occur. The feature “Operating System: H001” 350 may also have a message that requires user attention, as indicated by message indica 354. Locked indicia 356 determines that the feature has a locked (e.g., password protected) security setting. Finally, placeholder icon 358 indicates that the feature has no scheduled tasks. This combination of attributes clearly indicates the status of the data processing system feature.

As in many program interfaces, the user may alter the appearance of system resource monitor interface 300. With reference to FIG. 4B, there is illustrated a view of system resource monitor interface 300 in which window 320 may be sized utilizing sizing tool 324, controlled by mouse 34. The user may choose to view more of the textual identifications of tree structure 302 by reducing the viewable area of window 320. FIG. 4C illustrates that the visual appearance of system resource monitor interface 300 may further be customized by altering the viewable order of the columns in window 320 utilizing mouse 34 to click and drag column 325 to the desired location.

With reference to FIG. 4D, there is illustrated another view of system resource monitor interface 300 in which the user may select to view only the desired attributes by utilizing pull-down menu 326, which may be invoked by clicking the right button of mouse 34 on title bar 322. When an attribute is listed on pull-down menu 326 with an adjacent checkmark 328, the attribute is viewable in window 320. The attribute column may be removed from view by deselecting the attribute on pull-down menu 326.

Referring to FIG. 4E, there is depicted another view of system resource monitor interface 300 in which “hover help” is invoked. Utilizing mouse 34, the user may place the mouse cursor over a section of title bar 322. After waiting a few seconds, hover help bar 330 appears to describe (utilizing text) notification indicia 332 in title bar 322, as indicated by the mouse cursor.

Referring the FIG. 4F, there is depicted another view of system resource monitor interface 300 in which a second view of title bar 322 may be invoked by the user. This second view includes text descriptions 334 instead of graphical indicia in title bar 322.

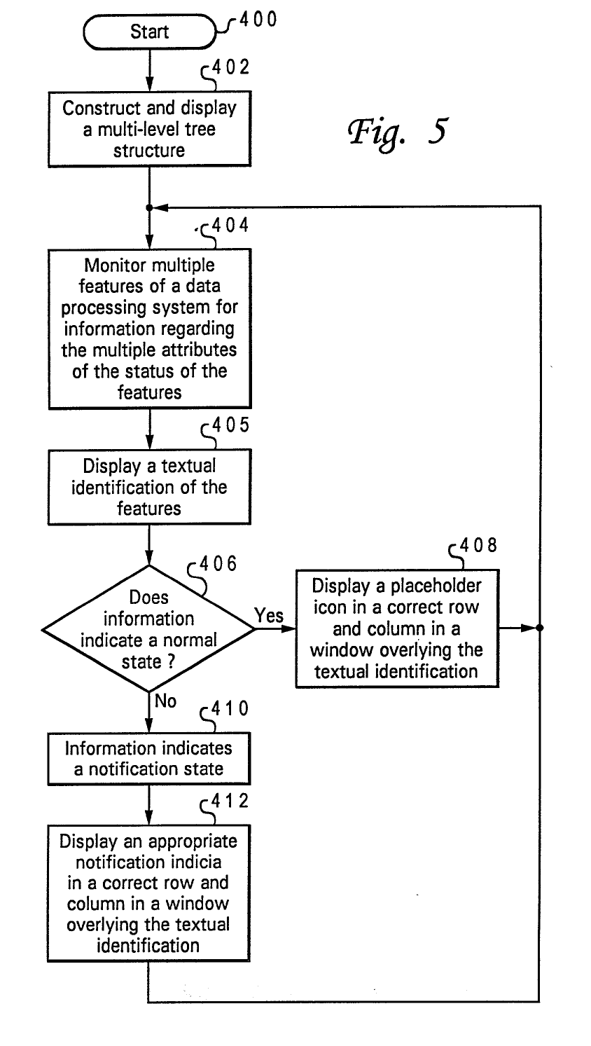

Referring now to FIG. 5, a high-level logic flowchart depicting a preferred method of indicating to a user the status of multiple features within a data processing system is illustrated. The preferred embodiment of the present invention can implement the feature status indication method utilizing a system resource monitor 54 stored in memory 26 and executable by CPU 24 of data processing system 10. The preferred method of indicating a status of multiple features results in the display of a multi-level tree structure including indications regarding the status of the components in the data processing system.

The process begins as illustrated in block 400 and continues to block 402, which depicts the display of a multi-level tree structure. Each level of the multi-level tree structure includes a textual identification for a respective one of multiple features within data processing system 10. Next, the process enters a monitoring loop including blocks 404-412. As depicted in block 404, a system resource monitor observes the multiple features within data processing system 10 for information regarding a status of one of the multiple features. A textual identification of each of the features is displayed by system resource monitor 54, as illustrated in block 405.

If the information indicates a normal state, as illustrated in block 406, the process continues to block 408, which depicts the system resource monitor displaying a placeholder icon in a correct row and column in a window adjacent to the multi-level tree structure. The process returns to block 404 from block 408. If, as illustrated in block 410, the information indicates a notification state, the system resource monitor displays one of various graphically distinct indicia providing indication of an attribute of the feature in the window adjacent to the multi-level tree structure, as shown in block 412. The process returns to block 404 from block 412.

As described above, an improved system and method for indicating a status of multiple features within a data processing system to a user is presented. An exemplary data processing system, as implemented according to a preferred embodiment of the present invention, includes a system resource monitor, stored in a memory and executable by a processor. The system resource monitor observes the status of the features and displays various graphically distinct indicia on the system resource monitor interface depending on the status of the features. The user can clearly ascertain the status of multiple features of a data processing system because the system resource monitor displays a textual identification of the feature and a placeholder icon if the feature is functioning normally. When the system resource monitor observes a notification status for a feature, various graphically distinct indicia are displayed adjacent the textual identification of the feature by the system resource monitor. If the status of at least one of the multiple features comprises multiple attributes, system resource monitor displays a window adjacent to the multi-tree structure. System resource monitor displays in the window a placeholder icon for attributes having a normal state and a notification icon for attributes having a notification state.

Although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

While the invention has been particularly shown and described with reference to a preferred embodiment, it will also be understood by those skilled in the art that various changes in form and detail may be made therein without departing from the spirit and scope of the invention.

What is claimed is:

1. A method of indicating a status of a plurality of features of a data processing system to a user, said method comprising:
displaying a graphical multi-level tree structure, wherein each level in said tree structure includes a textual identification for a respective one of said plurality of features;
monitoring said plurality of features for information regarding said status of said plurality of features, wherein said status for at least a first feature among said plurality of features comprises a plurality of attributes;
displaying a window associated with said multi-level tree structure, wherein said window comprises a plurality of fields for indicating a status of a respective one of said plurality of features;
in said field associated with said first feature, displaying notification indicia for multiple ones of said plurality of attributes.

2. The method of claim 1, and further comprising determining if said information indicates a normal state or a notification state, wherein said step of displaying a notification indicia for multiple ones of said plurality of attributes comprises displaying notification indicia for only those attributes among said plurality of attributes indicated by said information as being in said notification state.

3. The method of claim 2, wherein:
said determining includes determining a nature of said notification state; and
said step of displaying notification indicia includes displaying an appropriate graphically distinct notification indicia, in response to determining the nature of said notification state.

4. The method of claim 3, wherein:
said determining step comprises determining whether said notification state is a warning state or an error state; and
said step of displaying an appropriate graphically distinct notification indicia comprises displaying a warning indicia in response to determining said notification state is said warning state and displaying an error indicia in response to determining said notification state is said error state.

5. The method of claim 2, and further comprising:
displaying a placeholder icon for each one of said plurality of attributes that said information indicates is in said normal state.

6. A data processing system, comprising:
a processor;
a user interface coupled to said processor, said user interface including a display; and
a memory coupled to said processor, said memory including a system resource monitor executable by said processor to display a graphical multi-level tree structure including a textual identification of each of a plurality of features of the data processing system, said status for at least a first feature among said plurality of features comprising a plurality of attributes, wherein said system resource monitor observes said plurality of features for information regarding a status of said plurality of features and displays, in association with said multi-level tree structure, a window including a plurality of fields each utilized for indicating a status of a respective one of said plurality of features, said system resource monitor further displaying, in said field associated with said first feature, a notification indicia for multiple ones of said plurality of attributes.

7. The data processing system of claim 6, said system resource monitor comprising:
means for determining if said information indicates a normal state or a notification state; and
means for displaying notification indicia for only those attributes among said plurality of attributes indicated by said information as being in said notification state.

8. The data processing system of claim 7, wherein:
said means for determining includes means for determining a nature of said notification state; and
said means for displaying notification indicia comprises means for displaying an appropriate graphically distinct notification indicia in response to determining the nature of said notification state.

9. The data processing system of claim 8, wherein:
said means for determining comprises means for determining whether said notification state is a warning state or an error state; and
said means for displaying an appropriate graphically distinct notification indicia comprises means for displaying a warning indicia in response to determining said notification state is said warning state and for displaying an error indicia in response to determining said notification state is said error state.

10. The data processing system of claim 7, and further comprising:
means for displaying a placeholder icon for each one of said plurality of attributes that said information indicates is in said normal state.

11. A program product, comprising:
a computer-usable medium; and
a system resource monitor encoded within said computer-usable medium and executable by a processor of a data processing system to display a graphical multi-level tree structure including a textual identification of each of a plurality of features of the data processing system, said status for at least a first feature among said plurality of features comprising a plurality of attributes, wherein said system resource monitor further observes said plurality of features for information regarding a status of said plurality of features and displays, in association with said multi-level tree structure, a window including a plurality of fields each utilized for indicating a status of a respective one of said plurality of features, said system resource monitor further displaying, in said field associated with said first feature, a notification indicia for multiple ones of said plurality of attributes.

12. The program product of claim 11, said system resource monitor comprising:
instruction means for determining if said information indicates a normal state or a notification state; and
instruction means for displaying notification indicia for only those attributes among said plurality of attributes indicated by said information as being in said notification state.

13. The program product of claim 12, wherein:
said instruction means for determining includes instruction means for determining a nature of said notification state; and
said instruction means for displaying notification indicia comprises instruction means for displaying an appropriate graphically distinct notification indicia in response to determining the nature of said notification state.

14. The program product of claim 13, wherein:
said instruction means for determining comprises instruction means for determining whether said notification state is a warning state or an error state; and
said instruction means for displaying an appropriate graphically distinct notification indicia comprises instruction means for displaying a warning indicia in response to determining said notification state is said warning state and for displaying an error indicia in response to determining said notification state is said error state.

15. The program product of claim 12, and further comprising:
instruction means for displaying a placeholder icon for each one of said plurality of attributes that said information indicates is in said normal state.
